(19) United States
(12) Patent Application Publication
(10) Pub. No.: US 2025/0348050 A1
(43) Pub. Date: Nov. 13, 2025

(54) CONTROL SYSTEM, CONTROL DEVICE AND METHOD FOR PROVIDING AN OPEN- AND/OR CLOSED-LOOP CONTROL SIGNAL

(71) Applicant: Elmos Semiconductor SE, Dortmund (DE)

(72) Inventors: Ruediger Arnold, Berlin (DE); Michal Cwiklinski, Falkensee (DE); Felix Brose, Berlin (DE); Robert Pyka, Düsseldorf (DE)

(73) Assignee: Elmos Semiconductor SE, Dortmund (DE)

(21) Appl. No.: 19/277,631

(22) Filed: Jul. 23, 2025

Related U.S. Application Data
(63) Continuation of application No. PCT/EP2024/052073, filed on Jan. 29, 2024.

(30) Foreign Application Priority Data
Jan. 31, 2023 (LU) LU503412

(51) Int. Cl. G05B 19/042

(52) U.S. Cl. CPC G05B 19/0428; G05B 19/0423

(57) ABSTRACT

Provided is a control system which is configured to provide control and/or regulating signals, comprising a system bus with a system controller, wherein the system controller is configured to execute system functions of the control system; a measurement bus with a measurement controller, wherein the measurement controller is configured to execute measurement functions for acquiring and/or processing measurement data and/or output functions for adapting and/or outputting control and/or regulating signals, wherein the measurement controller includes or is a deterministic, programmable finite-state machine and is configured such that the measurement functions and/or output functions executable by the measurement controller are fully simulatable, and wherein the measurement controller is operable using a predetermined program code, wherein the measurement controller has a ROM memory and the predetermined program code is provided in the ROM memory; and a bus interface providing a communication connection between the system bus and the measurement bus.

### CROSS REFERENCE TO RELATED APPLICATIONS

This application is a continuation application of international patent application PCT/EP2024/052073, filed on Jan. 29, 2024, and designating the U.S., which claims priority to Luxembourg patent application LU503412, filed on Jan. 31, 2023, each of which are hereby incorporated by reference in their entireties.

### TECHNICAL FIELD

The disclosure can relate to a control system, a control device, a use of a RISC processor as a measurement controller in a control system, and/or a method for providing a control and/or regulating signal. The disclosure may be in the field of control systems and control devices, optionally for the automotive sector.

### BACKGROUND

Control systems can have complex integrated measurement systems for acquiring measurement signals and generating output data. The elaboration and control of the measuring section is traditionally carried out by microcontrollers. In addition to the elaboration of the measurement data and the control of the measuring section, the microcontroller is also traditionally responsible for controlling the system functions. The multitude of functions that have to be performed by the microcontroller often leads to a loss of speed of the microcontroller and also makes it difficult to guarantee functional safety. Therefore, conventional microcontrollers often reach their limits when executing measurement and control functions in addition to system control.

U.S. Pat. No. 10,108,168 B2 describes a monitoring network and a computer-executable method for automated monitoring of a control system.

US 2022/0028713 A1 describes a method for determining whether an adaptation of a manufacturing process recipe is provided.

US 2022/0334988 A1 describes an input/output station for a fieldbus system with a fieldbus coupler that has a system bus interface and a fieldbus interface.

US 2021/0135942A1 describes methods for automatically configuring a computing device in a computer environment.

### SUMMARY

Provided is a control system which is configured to provide control and/or regulating signals. The control system comprises a system bus with a system controller, wherein the system controller is configured to execute system functions of the control system; a measurement bus with at least one measurement controller, wherein the at least one measurement controller is configured to execute measurement functions for acquiring and/or processing measurement data and/or output functions for adapting and/or outputting control and/or regulating signals, wherein the measurement controller includes or is a deterministic, programmable finite-state machine and is configured such that the measurement functions and/or output functions executable by the measurement controller are fully simulatable, and wherein the measurement controller is operable using a predetermined program code, wherein the measurement controller has a ROM memory and the predetermined program code is provided in the ROM memory; and a bus interface providing a communication connection between the system bus and the measurement bus.

Provided is a method for providing a control and/or regulating signal. The method comprises providing a system bus with a system controller, wherein the system controller is configured to execute system functions of the control system; providing a measurement bus with at least one measurement controller, wherein the at least one measurement controller is configured to execute measurement functions for acquiring and/or processing measurement data and/or output functions for adapting and/or outputting control and/or regulating signals, wherein the measurement controller is or includes a deterministic, programmable finite-state machine and is configured such that the measurement functions and/or output functions executable by the measurement controller are fully simulatable, and wherein the measurement controller is operable using a predetermined program code, the measurement controller has a ROM memory and the predetermined program code is provided in the ROM memory; sending a command for executing a measurement function from the system controller to the measurement controller via a bus interface, which provides a communication connection between the system bus and the measurement bus; executing the measurement function by the measurement controller and preventing the system controller from accessing the measurement controller during execution of the measurement function by the measurement controller; and providing output data that was created during the execution of the measurement function, wherein the output data is provided to the system controller via the bus interface.

### DESCRIPTION OF THE DRAWINGS

In the drawings:

FIG. 1 shows a schematic and exemplary representation of a control system according to an optional embodiment;

FIG. 2 shows a schematic and exemplary representation of a measurement controller according to an optional embodiment;

FIG. 3 shows a schematic and exemplary representation of a control system according to a further optional embodiment;

FIG. 4 shows a schematic and exemplary representation of a control device according to an optional embodiment;

FIG. 5 shows a schematic and exemplary illustration of a method for providing a control and/or regulating signal; and

FIG. 6 shows a schematic and exemplary representation of an integrated circuit according to an optional embodiment.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

One possible object of the disclosure may be to simplify ensuring of functional safety and increasing a speed of a control system.

In a first possible aspect, an integrated circuit for providing a control system for providing control and/or regulation signals can be provided. That is, an integrated circuit for providing an open- and/or closed-loop control signal may be provided. The integrated circuit comprises a system bus with a system controller, wherein the system controller is configured to execute system functions of the control system. The integrated circuit further comprises a measurement bus with at least one measurement controller, wherein the at least one measurement controller is configured to execute measurement functions for acquiring and/or processing measurement data and/or output functions for adapting and/or outputting control and/or regulating signals. In addition, the integrated circuit comprises a bus interface which is configured to provide a communication connection between the system bus and the measurement bus.

In a further possible aspect, a control system can be provided which is configured to provide control and/or regulation signals. The control system comprises a system bus with a system controller, wherein the system controller is configured to execute system functions of the control system. The control system is characterized in that the control system further comprises a measurement bus with at least one measurement controller, wherein the at least one measurement controller is configured to execute measurement functions for acquiring and/or processing measurement data and/or output functions for adapting and/or outputting control and/or regulating signals, wherein the measurement controller is designed as a deterministic, programmable finite state machine and is configured such that the measurement functions and/or output functions executable by the measurement controller can be fully simulated. In addition, the control system has a bus interface which is configured to provide a communication connection between the system bus and the measurement bus.

In another possible aspect, the use of a RISC processor as a measurement controller in a control system can be provided.

In a further possible aspect, a control device for a motor vehicle can be provided, which comprises a control system according to the disclosure.

In a further possible aspect, a method for providing a control and/or regulation signal can be provided. The method comprises providing a system bus with a system controller, wherein the system controller is configured to execute system functions of the control system. The method also comprises providing a measurement bus with at least one measurement controller, wherein the at least one measurement controller is configured to execute measurement functions for acquiring and/or processing measurement data, wherein the measurement controller is designed as a deterministic, programmable finite state machine and is configured such that the measurement functions and/or output functions executable by the measurement controller can be fully simulated. In addition, the method comprises sending a command to execute a measurement function from the system controller to the measurement controller via a bus interface which provides a communication connection between the system bus and the measurement bus. Furthermore, the method comprises executing the measurement function by the measurement controller and preventing the system controller from accessing the measurement controller while the measurement function is being executed by the measurement controller, as well as providing output data that was created during the execution of the measurement function, wherein the output data is provided to the system controller via the bus interface.

A control system can be defined as a system for controlling and/or regulating an associated system or control loop. The control system may comprise several components, e.g. the system controller and one or more measurement controllers. The multiple components may be present as a coherent arrangement and optionally housed together on a circuit board and/or in a housing. Alternatively, several components of the control system may exist separately from one another. Control and/or regulation signals can be those signals which are provided by the control system in order to control a connected measuring section and/or to control a control loop. The control and/or regulation can include the acquisition of measurement signals, the elaboration of the measurement signals and the control of a measuring section.

The term “BUS” or “Bus” according to the present disclosure can be understood in the sense of the generally used abbreviation for the English term “Binary Unit System”. Accordingly, a bus can be a system for data transmission between multiple participants via a common transmission path. A “system bus” can be therefore understood to be a system for data transmission between multiple participants who are at least partially involved in the execution of system functions. The system controller can be one of the participants in the system bus. A measurement bus can be a system for data transmission between several participants which are at least partially involved in the execution of measurement functions and/or output functions. The measurement controller can be one of the participants in the measurement bus. The system bus and the measurement bus can be designed separately from each other, i.e. each as an independent bus. The system bus and the measurement bus can be connected to each other via the bus interface so that communication can take place between participants of the system bus and the measurement bus. The communication and/or exchange of data may be limited to certain types of data and/or information, to a certain direction of the information flow, to certain participants and/or to certain periods of time.

A system function can be a function that serves to control the control system. A system function can therefore form part of an operating system of the control system and serve the basic function of the system function. The operating system can comprise several system functions which, together with the hardware properties of the control system, form the basis for the operation of the control system and, optionally, control and monitor the processing of programs and more specific functions. The system functions are carried out by the system controller. The system controller may comprise a microcontroller or be designed as such.

A measurement function can be a function that serves a predetermined measurement. Individual or different measurement functions can relate to the acquisition of measurement data and/or the processing of measurement data. The measurement functions can be carried out by a measurement controller. A measurement controller can be designed to perform one or more measurement functions. The acquisition of measurement data can include reading out sensor data from one or more sensors participating in the measurement bus. The processing of measurement data may include improving the quality of the measurement data, such as filtering and/or amplifying and/or applying noise suppression to the measurement data.

An output function can be a function that serves to adapt control and/or regulating signals and/or to output control and/or regulating signals, for example to the control loop and/or to an actuator. A measurement controller can be designed to perform one or more output functions and optionally one or more measurement functions. Adapting the control and/or regulation signals may comprise modifying predefined control and/or regulation signals, for example based on instructions provided by the system controller and/or based on information determined by the measurement controller itself or another measurement controller. The output of control and/or regulation signals can represent a provision of the control and/or regulation signals to an actuator or to a measuring section or to a control loop in general.

An integrated circuit can represent an electronic component in which all components of the integrated circuit are integrated. The integrated circuit may optionally be provided in monolithic form and/or arranged on a common board. The integrated circuit can optionally provide the control system as a “system-on-a-chip”, i.e. the control system with all associated components in the form of an electronic chip and optionally in the form of a semiconductor chip.

The fact that the at least one measurement controller can be designed as a finite state machine may mean that the at least one measurement controller can only be in one of a limited number of possible states. The fact that this can be a deterministic finite-state machine may mean that the finite-state machine transitions from one state to another in a deterministic manner, i.e. in a predetermined manner, where the predetermined manner can depend on the initial state and on an input provided to the finite-state machine. The fact that the finite state machine can be programmable may mean that the program sequences to be carried out by the finite state machine, which determine, for example, the deterministic way in which the finite state machine transitions to another state depending on the initial state and a provided input, can be specified and/or changed by programming. The design of the at least one measurement controller as a deterministic, programmable finite state machine can offer the advantage that the measurement functions and/or output functions executable by the measurement controller can be fully simulated.

Optionally, the disclosure can offer the advantage that the control system can be designed flexibly, quickly and easily, since the components suitable for the respective application can be assembled in a modular manner. For example, one or more measurement controllers can be combined with the system controller depending on the intended functionality. Since the measurement tasks can be carried out by the respective measurement controller(s), the system controller can primarily execute the system functions without having to allocate a large part of its computing power to measurement functions.

Optionally, the disclosure can offer the advantage that the measurement controllers can be programmed and optimized independently of the system controller and vice versa. It may optionally be possible for the system controller to be used across platforms in a variety of different control systems, while one or more different measurement controllers may be added to the control system depending on the intended use of the control system. Furthermore, this may offer the advantage that the system controller can be adapted or programmed to customer-specific requirements, for example by the manufacturer or the customer, while the measurement controllers for the hardware-related tasks of measured value acquisition, etc., can be provided in a manner that cannot be changed by the customer.

Optionally, the disclosure may also offer the advantage that the measurement controllers and the system controller can each be provided as self-contained systems and can be simplified accordingly for verification of the control system with regard to functional safety. Optionally, a clear separation of the system bus from the measurement bus can be achieved by means of the bus interface, and accordingly a separation of the hardware-related measurement signal acquisition, measurement signal processing and control on the one hand, and the higher system functions carried out by the system controller on the other hand, which is advantageous for functional safety, can be achieved.

Optionally, the measurement controller or optionally the multiple measurement controllers can each have one or more RISC processors. The RISC processor(s) can represent the only arithmetic-logic unit (ALU) of the measurement controller or, if there are multiple RISC processors, they can represent the only ALUs of the measurement controller. “RISC” stands for “Reduced Instruction Set Computer” and means that the RISC processor can have a reduced or even minimized instruction set compared to a system processor designed as a microcontroller. Due to the reduced or even minimized instruction set and a low logical depth, the number of possible alternatives that the RISC processor can have to check when executing a function can be reduced and the time required for this can be reduced accordingly. Optionally, a RISC processor can offer the advantage of delivering high computing power in a short time. In addition, the RISC processor can have lower power consumption than a microcontroller with greater logical depth and a more detailed instruction set than the RISC processor. Optionally, given its optional or possible low complexity, the measurement controller can be referred to as a “nanocontroller” in contrast to a microcontroller.

Traditionally, RISC processors can be used to obtain either particularly fast processors or processors with particularly low power consumption. In addition, RISC processors are not traditionally used in a control system; instead, in order to save hardware components, both the system functions and the measurement functions are carried out by the system controller, which can be designed as a microcontroller, for example. According to the disclosure, RISC processors can be used as measurement controllers and integrated into a measurement bus to perform small and compact functions related to measurement data and the output of control and regulation signals. This may offer great flexibility for a modular design of a measuring system and can provide module-based safeguarding with regard to functional safety.

The measurement controller can be operated using a predefined program code. For this purpose, the measurement controller can have a ROM memory, wherein the specified program code can be provided in the ROM memory. Optionally, the ROM memory can be in wired form.

This can offer the advantage that the program code provided in the ROM memory cannot be manipulated or changed, and thus a change in the functionality and the program code can only be made within the context of a hardware modification. This can offer the advantage that a high level of protection for functional safety can be achieved and, optionally, accidental or unauthorized changes to the program code provided for the measurement controller by unauthorized persons can be prevented or made more difficult.

The measurement controller can optionally be designed as a finite state machine. The measurement functions and/or output functions that can be executed by the measurement controller can be fully simulated. This can offer the advantage that the measurement controller(s) can each be treated as finite state machines within the framework of functional safety, especially if the specified program code is provided in a ROM memory and the functionality of the measurement controller can be fully simulated. Accordingly, within the framework of functional safety, the effort required for testing and/or verifying the functionality of the measurement controller can be reduced or even minimized. In addition, this can offer the advantage that the functionality of the measurement controller can optionally be fully mapped in a simulation, which can further reduce the testing and/or verification effort. Thus, a measurement controller can be fully simulated in the form of a finite state machine and examined for compliance with safety rules using rule-based verification. This offers significant advantages over more complex processors, such as microcontrollers, where simulation and rule-based verification are typically not possible due to the large number of possible states.

The measurement controller can be configured to execute each measurement function or output function executable by the measurement controller starting from an initial state within a predetermined finite cycle and to return to the initial state after the expiration of the predetermined finite cycle. This can be advantageous in terms of functional safety, since a regular reset of the measurement controller takes place and failure of the measurement controller due to prolonged hanging of the operation can be avoided. The predetermined finite cycle may, for example, have a time duration of 50 μs or less, and optionally have a time duration of 20 μs or less. This ensures that the functionality of the measurement controller is available again at the latest after the end of the finite cycle.

The measurement controller can optionally be configured to execute a maximum of 32 or even just 16 different commands. This can enable a particularly efficient implementation of the measurement controller using a RISC processor, which can also allow for a particularly efficient verification of functional safety.

The measurement controller may further comprise a RAM memory and be configured to store output data generated when a measurement function is executed in the RAM memory. The RAM memory can optionally be used only for storing and, optionally, temporarily storing measurement data or output data which are to be transferred to the system controller via the bus interface. Thus, optionally, the RAM memory can represent part of an interface from the measurement bus to the system bus and provide a suitable platform for data exchange between the measurement bus and the system bus. Accordingly, the control system can be configured to enable the system controller to access the RAM memory of the measurement controller and to read the output data from the RAM memory of the measurement controller via the bus interface.

In addition, the system controller may also have a RAM memory, wherein the control system may be configured to store the output data via the bus interface in the RAM memory of the system controller.

Optionally, the predefined program code can be provided in a RAM memory and the measurement controller can be operated in a test mode using the predefined program code stored in the RAM memory. For example, the RAM memory can be designed as flash memory in the measurement controller. This offers the possibility of providing the specified program code in a changeable form during test operation, for example to test adaptations and/or changes to the specified program code during test operation, without the need to provide a new ROM memory for each change. However, for functional operation, i.e. the intended operation during regular use of the control system, it may be necessary for the predefined program code to be provided in a ROM memory and for the measurement controller to be operable in functional operation exclusively by means of the predefined program code stored in the ROM memory. This can prevent or make it more difficult to manipulate the given program code.

The measurement functions and/or output functions that can be executed by the measurement controller can optionally include applications that are safety-relevant within the framework of functional safety. This enables separate verification of the measurement controller and the applications executed by it without necessarily having to include more complex components, such as a system controller designed as a microcontroller.

The control system may be configured to prevent the system controller from accessing the measurement controller during the execution of a measurement function and/or output function by the measurement controller. This offers the possibility of avoiding disturbances and/or other influences that may affect the operation of the measurement controller when executing a measurement function and/or output function, and accordingly increasing functional safety. Optionally, this can prevent unwanted manipulation of the functionality of the measurement controller by the intervention of the system controller.

The control system may be configured to provide a clock signal and to synchronize the system controller and the at least one measurement controller with the clock signal. This can offer the advantage that the system controller and at least one measurement controller can be operated in the same clock domain. This in turn can offer the advantage that synchronization of the operation of the system controller and the operation of at least one measurement controller can be achieved. This in turn can offer the advantage that a temporal adjustment and/or allocation of work processes and/or work results of the system controller and at least one measurement controller can be facilitated. The clock signal can optionally be provided by a clock generator of the control system.

The control system may be configured such that the at least one measurement controller is operable independently of the system controller and/or the system controller is operable independently of the at least one measurement controller. This can offer the advantage that any undesirable influences of the system controller on the operation of the measurement controller or vice versa can be reduced or avoided. In addition, this can offer the advantage that the measurement controllers can be designed separately from the system controller as self-contained elements or systems and can optionally be designed to be fully simulatable without their operation necessarily having to depend on the functions of the system controller.

The system controller, the at least one measurement controller and the bus interface can optionally be integrated into an integrated circuit. Optionally, all components of the control system can be integrated into the integrated circuit. This can offer the advantage of providing the control system in the form of a system-on-a-chip. This can offer the advantage that the control system can be provided as a single component and optionally installed as a unit on a circuit board and/or in other electrical systems if required.

The control system may further comprise a RAM memory, wherein the control system may be configured to store output data generated by the at least one measurement controller when executing a measurement function in the RAM memory and to access the RAM memory by means of the system controller and to read the output data from the RAM memory. The RAM memory can be integrated into an integrated circuit together with other components of the control system. The RAM memory can form part of the system controller, or form part of a measurement controller, or be formed separately from the system controller and the at least one measurement controller.

The integrated circuit can be designed such that the measurement controller is designed as a deterministic, programmable finite state machine and is configured such that the measurement functions and/or output functions executable by the measurement controller can be fully simulated.

The integrated circuit may further comprise a RAM memory, and may be configured to store output data generated by the at least one measurement controller when executing a measurement function in the RAM memory and to access the RAM memory by means of the system controller and to read the output data from the RAM memory. The RAM memory can optionally be designed separately from the system controller and separately from the at least one measurement controller.

The integrated circuit may further comprise a clock generator for providing a clock signal, wherein the integrated circuit may be configured to synchronize the system controller and the at least one measurement controller by means of the clock signal. This can offer the advantage that the system controller and the at least one measurement controller can be operated in the same clock domain. This in turn can offer the advantage that synchronization of the operation of the system controller and the operation of at least one measurement controller can be achieved. This in turn can offer the advantage that a temporal adjustment and/or allocation of work processes and/or work results of the system controller and at least one measurement controller can be facilitated.

The integrated circuit may be configured such that the at least one measurement controller is operable independently of the system controller and/or the system controller is operable independently of the at least one measurement controller. This can offer the advantage that any undesirable influences of the system controller on the operation of the measurement controller or vice versa can be reduced or avoided. In addition, this can offer the advantage that the measurement controllers can be designed separately from the system controller as self-contained elements or systems and can optionally be designed to be fully simulatable without their operation necessarily having to depend on the functions of the system controller.

All disclosures relating to the control system shall also be deemed to be disclosed for the integrated circuit and the method and vice versa.

Furthermore, a control device for a motor vehicle is provided. The control device may comprise a control system according to the disclosure. The features disclosed for the control system are also to be considered as disclosed for the control device.

The features and embodiments mentioned above and explained below are not only to be regarded as disclosed in the respective explicitly mentioned combinations, but are also encompassed by the disclosure content in other technically meaningful combinations and embodiments.

In the following FIGS., identical or similar elements in the various embodiments are designated by identical reference numerals for the sake of simplicity.

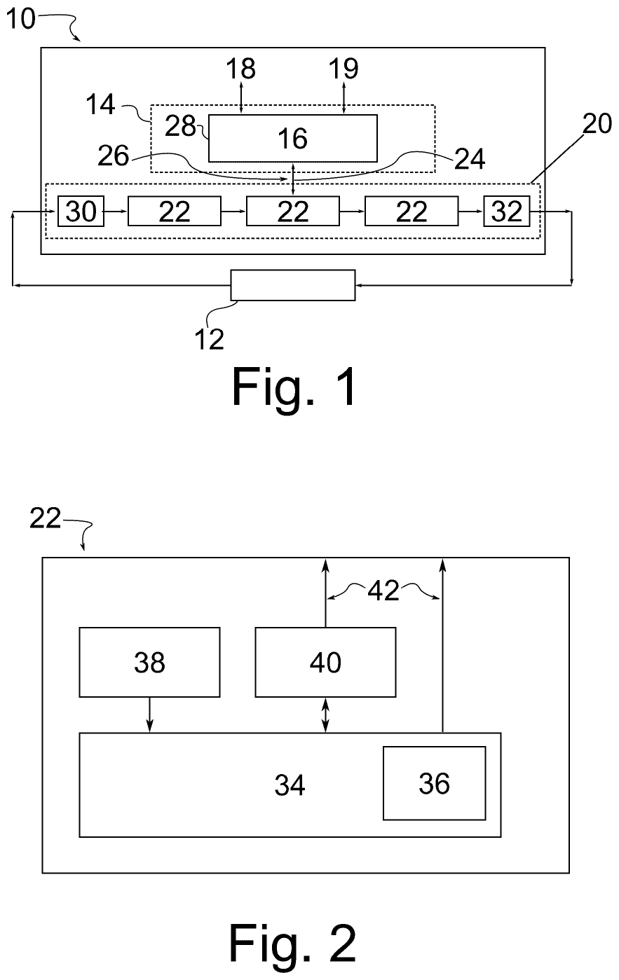

FIG. 1 shows a schematic representation of a control system 10 according to an optional embodiment, which is configured to provide control and/or regulating signals for controlling a control section 12. The control system 10 comprises a system bus 14 with a system controller 16, wherein the system controller 16 is configured to execute system functions 18 of the control system 10. The control system 10 is characterized in that the control system 10 further comprises a measurement bus 20 with at least one measurement controller 22, wherein the at least one measurement controller 22 is configured to perform measurement functions for acquiring and/or processing measurement data and/or output functions for adapting and/or outputting control and/or regulating signals. According to the embodiment shown, the control system 10 has three measurement controllers 22 in the measurement bus 20. In addition, the control system has a bus interface which is configured to provide a communication connection 26 between the system bus. 14 and the measurement bus 20.

The system controller 16 may comprise a microcontroller 28 or be designed as such. The system controller may further be configured to enable communication 19 of other components that do not belong to the measurement system 10 with the measurement system 10.

The control section 12 can be an analog system. Accordingly, the control system may further comprise an analog-to-digital converter (ADC) 30 at the input of the measurement bus 20, as well as a digital-to-analog converter (DAC) 32 at the output of the measurement bus 20. The control system 10 can be configured so that the measurement controller 22 arranged directly after the ADC has exclusive access to the output of the ADC 30 and/or so that the measurement controller 22 arranged directly before the DAC 32 has exclusive access to the input of data into the DAC 32.

FIG. 2 shows a schematic representation of a measurement controller 22 according to an optional embodiment. The measurement controller 22 has an arithmetic logic unit (ALU) 34, which in the embodiment shown is designed as a RISC processor 36. The RISC processor 36 represents the only ALU 34 of the measurement controller 22. Furthermore, the measurement controller 22 may have a ROM memory 38 and a RAM memory 40 which are connected to the ALU 34. The ALU 34 and thus the RISC processor 36 and the measurement controller 22 can be operated by means of a predetermined program code, wherein the predetermined program code is provided in the ROM memory 38. In other words, the ALU 34 can only be operated with the predefined program code provided in the ROM memory 38. By using a RISC processor 36, the complexity of the measurement controller 22 can be kept low. Given its low complexity, the measurement controller 22 can generally be referred to as a “nanocontroller” in contrast to a microcontroller 28. In addition, this can ensure that the measurement controller 22 can only execute those commands and functions that are required for the intended task. The measurement controller 22 can optionally be designed as a finite state machine. This can offer the advantage that the measurement functions and/or output functions executable by the measurement controller 22 can be fully simulated, thereby facilitating verification of the function of the measurement controller 22 with regard to functional safety.

The measurement controller 22 can be configured to execute each measurement function or output function executable by the measurement controller 22 starting from an initial state within a predetermined finite cycle and to return to the initial state after the expiration of the predetermined finite cycle. The predetermined finite cycle may have a duration of 50 μs or less. In addition, the measurement controller 22 can be configured to execute a maximum of 32 different commands, which can facilitate verification of the measurement controller 22 with regard to functional safety.

The measurement controller 22 may further comprise a RAM memory 40 and be configured to store output data generated when a measurement function is executed in the RAM memory 40. Accordingly, the control system can be configured to enable the system controller 16 to access the RAM memory 40 of the measurement controller 22 and to read the output data from the RAM memory of the measurement controller via the bus interface 24. In addition, the system controller 16 may also have a RAM memory, wherein the control system 10 may be configured to store the output data via the bus interface 24 in the RAM memory of the system controller 16. In addition, the measurement controller 22 can have connections 42 to the bus interface 24.

Optionally, the predefined program code can be provided in a RAM memory 40 so that the measurement controller 22 can be operated in a test mode using the predefined program code stored in the RAM memory 40. This can be advantageous for testing modified program codes in a test mode without having to provide a modified ROM memory 38 for each change. In addition, however, the predetermined program code can be provided in a ROM memory 38, so that the measurement controller 22 can be operated in a functional mode exclusively by means of the predetermined program code stored in the ROM memory 38. This may be advantageous or necessary in terms of functional safety. The measurement functions and/or output functions that can be executed by the measurement controller 22 can comprise applications that are safety-relevant within the framework of functional safety. The control system 10 may be configured to prevent the system controller 16 from accessing the measurement controller 22 during the execution of a measurement function and/or output function by the measurement controller 22.

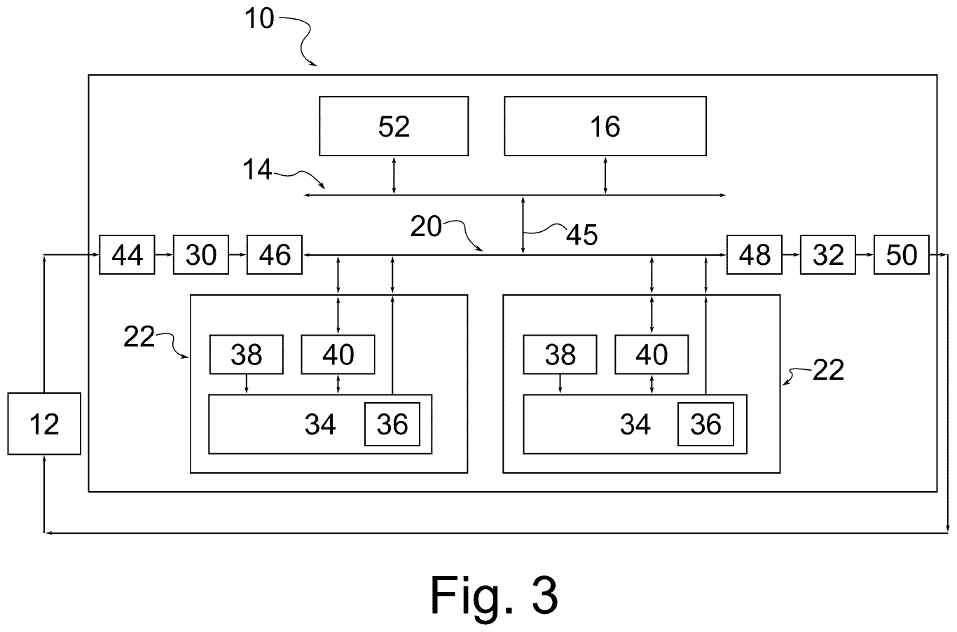

FIG. 3 shows a schematic representation of a control system 10 according to a further optional embodiment for controlling and/or regulating a control section 12 with an analog system. The control system 10 has a system bus 14 and a measurement bus 20. On the input side of the measurement bus 20 there is a front end 44, an ADC 30 and a control unit 46 for the ADC 30. Furthermore, the measurement bus 20 contains two measurement controllers 22 designed as nanocontrollers, as explained in detail above with reference to FIG. 2. On the output side, the measurement bus 20 contains a control unit 48 for the DAC 32, the DAC 32 and a driver 50 for the control section 12. The system bus 14 contains a system controller 16 designed as a microcontroller 28, as well as a register 52 which can provide the system controller 16 with data for particularly fast access.

The system controller 16 can have its own ROM memory, RAM memory and/or flash memory. The system controller 16 can retrieve the measurement data acquired and optionally processed and/or analyzed by one or more measurement controllers 22 via the bus interface 24 and use them to control the system. For example, one of the measurement controllers 22 may be responsible for acquiring the measured values or measurement data, while the other measurement controller 22 is responsible for elaborating the measured values or measurement data and controlling the DAC. As a result, the system controller 16 is decoupled from the components of the measurement bus not only in terms of development but also in terms of the bus. The measurement controllers 22 can be designed in the same way or differently from one another and can be adapted to their respective function or task. For example, different measurement controllers can be provided for data acquisition, elaboration and control. In addition, this can offer the advantage that the measurement system, i.e. the components of the measurement bus in the control system, can be designed to be programmable while maintaining the same front end. For example, reprogramming can be done by replacing the ROM memory and thereby adapting the predetermined program code of the measurement controller.

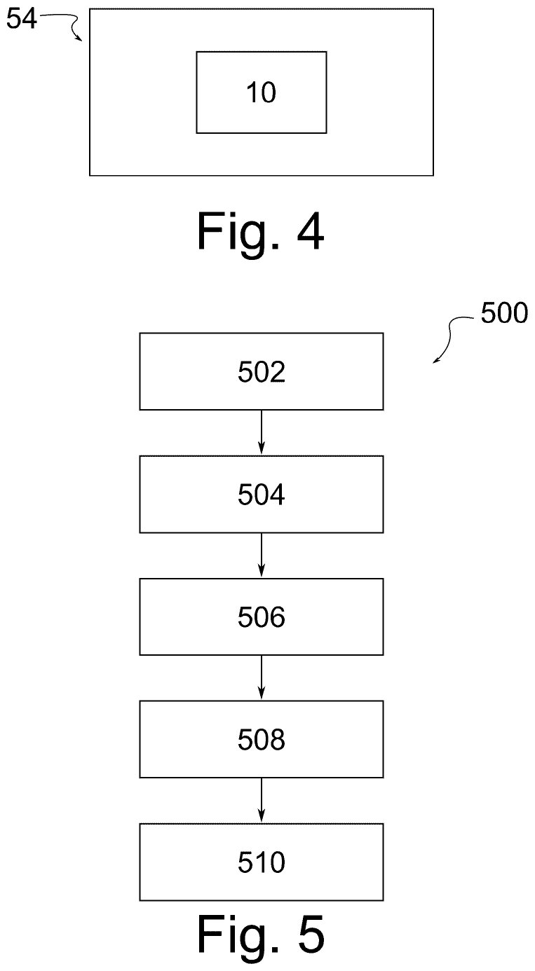

FIG. 4 shows a schematic representation of a control device 54 according to an optional embodiment for a motor vehicle. The control device 54 comprises a control system 10 according to the disclosure.

With reference to FIG. 5, a method 500 for providing a control and/or regulating signal is explained below.

The method 500 comprises in a step 502 the provision of a system bus 14 with a system controller 16, wherein the system controller 16 is configured to execute system functions 18 of the control system 10.

In step 504, the method 500 comprises providing a measurement bus 20 with at least one measurement controller 22, wherein the at least one measurement controller 22 is configured to perform measurement functions for acquiring and/or processing measurement data.

In step 506, the method 500 comprises sending a command for executing a measurement function from the system controller 16 to the measurement controller 22 via a bus interface 24, which provides a communication connection 26 between the system bus 14 and the measurement bus 20.

In step 508, the method 500 comprises executing the measurement function by the measurement controller 22 and preventing the system controller 16 from accessing the measurement controller 22 while the measurement function is being executed by the measurement controller 22.

In step 510, the method 500 comprises providing output data generated during execution 508 of the measurement function, wherein the output data is provided to the system controller 16 via the bus interface 24.

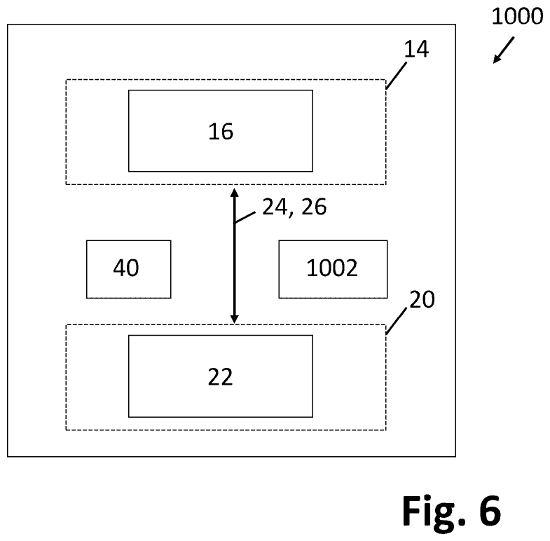

FIG. 6 shows a schematic representation of an integrated circuit 1000 for providing a control system 10 for providing control and/or regulating signals according to an optional embodiment. The integrated circuit 1000 comprises a system bus 14 with a system controller 16, wherein the system controller 16 is configured to execute system functions 18 (see FIG. 1) of the control system 10. The integrated circuit 1000 further comprises a measurement bus 20 with at least one measurement controller 22, wherein the at least one measurement controller 22 is configured to execute measurement functions for acquiring and/or processing measurement data and/or output functions for adapting and/or outputting control and/or regulating signals. In addition, the integrated circuit 1000 comprises a bus interface 24 which is configured to provide a communication connection 26 between the system bus 14 and the measurement bus 20.

The measurement controller 22 can be designed as a deterministic, programmable finite state machine and configured such that the measurement functions and/or output functions executable by the measurement controller 22 can be fully simulated.

The integrated circuit can further comprise a RAM memory 40, wherein the integrated circuit 1000 is configured to store output data created by means of the at least one measurement controller 22 during execution of a measurement function in the RAM memory 40 and to access the RAM memory 40 by means of the system controller 16 and to read out the output data from the RAM memory 40.

The integrated circuit 1000 may further comprise a clock generator 1002 for providing a clock signal, wherein the integrated circuit may be configured to synchronize the system controller 16 and the at least one measurement controller 22 by means of the clock signal.

The integrated circuit may be configured such that the at least one measurement controller 22 is operable independently of the system controller 16 and/or the system controller 16 is operable independently of the at least one measurement controller 22.

The disclosure further comprises the following subject matter:

1. An integrated circuit (1000) for providing a control system (10) for providing control and/or regulation signals, the integrated circuit comprising:
a system bus (14) with a system controller (16), wherein the system controller (16) is configured to execute system functions (18) of the control system (10);
a measurement bus (20) with at least one measurement controller (22), the at least one measurement controller (22) being configured to carry out measurement functions for acquiring and/or processing measurement data and/or output functions for adapting and/or outputting control and/or regulating signals; and.
a bus interface (24) which is configured to provide a communication connection (26) between the system bus (14) and the measurement bus (20).

2. The integrated circuit (1000) according to subject 1, wherein the measurement controller (22) is designed as a deterministic, programmable finite state machine and is configured such that the measurement functions and/or output functions executable by the measurement controller (22) can be fully simulated.

3. The integrated circuit (1000) according to subject 1 or 2, further comprising a RAM memory (40), wherein the integrated circuit (1000) is configured to store output data created by means of the at least one measurement controller (22) during execution of a measurement function in the RAM memory (40) and to access the RAM memory (40) by means of the system controller (16) and to read out the output data from the RAM memory (40).

4. The integrated circuit (1000) according to any one of the preceding subjects, further comprising a clock generator (1002) for providing a clock signal, wherein the integrated circuit is configured to synchronize the system controller (16) and the at least one measurement controller (22) by means of the clock signal.

5. The integrated circuit (1000) according to any one of the preceding subjects, wherein the integrated circuit is configured such that the at least one measurement controller (22) is operable independently of the system controller (16) and/or the system controller (16) is operable independently of the at least one measurement controller (22).

6. A control system (10) which is configured to provide control and/or regulating signals, the control system (10) comprising:
a system bus (14) with a system controller (16), wherein the system controller (14) is configured to execute system functions (18) of the control system (10);
a measurement bus (20) having at least one measurement controller (22), the at least one measurement controller (22) being configured to execute measurement functions for acquiring and/or processing measurement data and/or output functions for adapting and/or outputting control and/or regulating signals, the measurement controller (22) being designed as a deterministic, programmable finite-state machine and being configured in such a way that the measurement functions and/or output functions which can be executed by the measurement controller (22) can be completely simulated; and
a bus interface (24) which is configured to provide a communication connection (26) between the system bus (14) and the measurement bus (20).

7. The control system (10) according to subject 6, wherein the system controller (16) comprises or is designed as a microcontroller (28).

8. The control system (10) according to subject 6 or 7, wherein the measurement controller (22) comprises a RISC processor (36).

9. The control system (10) according to one of subjects 6 to 8, wherein the measurement controller (22) is operable by means of a predetermined program code.

10. The control system (10) according to subject 9, wherein the measurement controller (22) has a ROM memory (38) and wherein the predetermined program code is provided in the ROM memory (38).

11. The control system (10) according to one of the subjects 6 to 10, wherein the measurement controller (22) is configured to execute each measurement function or output function which can be executed by the measurement controller (22) in each case starting from an initial state within a predetermined finite cycle and to return to the initial state after expiration of the predetermined finite cycle.

12. The control system (10) according to subject 11, wherein the predetermined finite cycle has a time duration of 50 μs or less.

13. The control system (10) according to one of subjects 6 to 12, wherein the measurement controller (22) is configured to execute a maximum of 32 different commands.

14. The control system (10) according to one of subjects 6 to 13, wherein the measurement controller (22) further comprises a RAM memory (40) and is configured to store output data generated when a measurement function is executed in the RAM memory (40).

15. The control system (10) according to subject 14, wherein the control system (10) is configured to enable the system controller (16) to access the RAM memory (40) of the measurement controller (22) and to read the output data from the RAM memory (40) of the measurement controller (22) by means of the bus interface (24).

16. The control system (10) according to subject 14 or 15, wherein the system controller (16) has a RAM memory, and wherein the control system (10) is configured to store the output data into the RAM memory of the system controller (16) via the bus interface (24).

17. The control system (10) according to subject 9 or any of subjects 10 to 16, if back-referenced to subject 9, wherein
the predefined program code is provided in a RAM memory (40) and the measurement controller (22) can be operated in a test mode using the predefined program code stored in the RAM memory (40); and
the predetermined program code is provided in a ROM memory (38), so that the measurement controller (22) can be operated in a functional mode exclusively by means of the predetermined program code stored in the ROM memory (38).

18. The control system (10) according to one of the subjects 6 to 17, wherein the measurement functions and/or output functions executable by the measurement controller (22) comprise applications which are safety-relevant within the scope of functional safety.

19. The control system (10) according to one of subjects 6 to 18, wherein the control system (10) is configured to prevent access of the system controller (16) to the measurement controller (22) during the execution of a measurement function and/or output function by the measurement controller (22).

20. The control system (10) according to one of subjects 6 to 19, wherein the control system (10) is configured to provide a clock signal and to synchronize the system controller (16) and the at least one measurement controller (22) with the clock signal.

21. The control system (10) according to one of subjects 6 to 20, wherein the control system is configured such that the at least one measurement controller (22) is operable independently of the system controller (16) and/or the system controller (16) is operable independently of the at least one measurement controller (22).

22. The control system (10) according to one of the subjects 6 to 21, wherein the system controller (16), the at least one measurement controller (22) and the bus interface (24) are integrated into an integrated circuit.

23. The control system (10) according to any one of subjects 6 to 22, further comprising a RAM memory (40), wherein the control system is configured to store output data created by means of the at least one measurement controller (22), during execution of a measurement function, in the RAM memory (40) and to access the RAM memory (40) by means of the system controller (16) and to read out the output data from the RAM memory (40).

24. Use of a RISC processor (36) as a measurement controller (22) in a control system (10).

25. Use according to subject 24, wherein the measurement controller (22) is operable by means of a predetermined program code provided in a ROM memory (38), and wherein the measurement controller (22) is operable as a finite state machine by means of the predetermined program code.

26. A control device (54) for a motor vehicle, the control device (54) comprising a control system (10) according to any one of subjects 6 to 23.

27. A method (500) for providing a control and/or regulating signal, the method comprising:
providing (502) a system bus (14) with a system controller (16), wherein the system controller (16) is configured to execute system functions (18) of the control system (10);
providing (504) a measurement bus (20) having at least one measurement controller (22), the at least one measurement controller (22) being configured to execute measurement functions for acquiring and/or processing measurement data, the measurement controller (22) being designed as a deterministic, programmable finite-state machine and being configured in such a way that the measurement functions and/or output functions which can be executed by the measurement controller (22) can be completely simulated;
sending (506) a command for executing a measurement function from the system controller (16) to the measurement controller (22) via a bus interface (24), which provides a communication connection (26) between the system bus (14) and the measurement bus (20);
executing (508) the measurement function by the measurement controller (22) and preventing the system controller (16) from accessing the measurement controller (22) during execution of the measurement function by the measurement controller (22); and
providing (510) output data that was created during the execution of the measurement function, wherein the output data is provided to the system controller (16) via the bus interface (24).

### LIST OF REFERENCE CHARACTERS

10 control system
12 control section
14 system bus
16 system controller
18 system functions
19 communication
20 measurement bus
22 measurement controller
24 bus interface
26 communication connection
28 microcontroller
30 analog-to-digital converter
32 digital-to-analog converter
34 arithmetic logic unit (ALU)
36 RISC processor
38 ROM memory
40 RAM memory
42 connections to the bus interface
44 front end
46 control unit for ADC
48 control unit for DAC
50 driver
52 register
54 control device
500 method for providing a control and/or regulating signal
502-510 method steps
1000 integrated circuit
1002 clock generator

1. A control system (10) which is configured to provide control and/or regulating signals, the control system (10) comprising:
a system bus (14) with a system controller (16), wherein the system controller (14) is configured to execute system functions (18) of the control system (10);
characterized in that the control system (10) further comprises:
a measurement bus (20) with at least one measurement controller (22), wherein the at least one measurement controller (22) is configured to execute measurement functions for acquiring and/or processing measurement data and/or output functions for adapting and/or outputting control and/or regulating signals, wherein the measurement controller (22) is designed as a deterministic, programmable finite-state machine and is configured such that the measurement functions and/or output functions executable by the measurement controller (22) are fully simulable, and wherein the measurement controller (22) is operable by means of a predetermined program code, the measurement controller (22) has a ROM memory (38) and the predetermined program code is provided in the ROM memory (38); and
a bus interface (24) which is configured to provide a communication connection (26) between the system bus (14) and the measurement bus (20).

2. The control system (10) according to claim 1, wherein the system controller (16) comprises or is designed as a microcontroller (28).

3. The control system (10) according to claim 1 or 2, wherein the measurement controller (22) comprises a RISC processor (36).

4. The control system (10) according to any one of the preceding claims, wherein the measurement controller (22) is configured to execute each measurement function or output function executable by the measurement controller (22) in each case starting from an initial state within a predetermined finite cycle and to return to the initial state after expiry of the predetermined finite cycle.

5. The control system (10) according to claim 4, wherein the predetermined finite cycle has a time duration of 50 μs or less.

6. The control system (10) according to any one of the preceding claims, wherein the measurement controller (22) is configured to execute a maximum of 32 different commands.

7. The control system (10) according to any one of the preceding claims, wherein the measurement controller (22) further comprises a RAM memory (40) and is configured to store output data generated when a measurement function is executed in the RAM memory (40).

8. The control system (10) according to claim 7, wherein the control system (10) is configured to enable the system controller (16) to access the RAM memory (40) of the measurement controller (22) by means of the bus interface (24) and to read out the output data from the RAM memory (40) of the measurement controller (22).

9. The control system (10) according to claim 7 or 8, wherein the system controller (16) has a RAM memory, and wherein the control system (10) is configured to store the output data in the RAM memory of the system controller (16) via the bus interface (24).

10. The control system (10) according to any one of the preceding claims, wherein
the predefined program code is additionally provided in a RAM memory (40) and the measurement controller (22) can be operated in a test mode using the predefined program code stored in the RAM memory (40).
the measurement controller (22) can be operated in a functional mode exclusively by means of the predetermined program code stored in the ROM memory (38).

11. The control system (10) according to any one of the preceding claims, wherein the measurement functions and/or output functions executable by the measurement controller (22) comprise applications which are safety-relevant within the scope of functional safety.

12. The control system (10) according to any one of the preceding claims, wherein the control system (10) is configured to prevent the system controller (16) from accessing the measurement controller (22) during the execution of a measurement function and/or output function by the measurement controller (22).

13. The control system (10) according to any one of the preceding claims, wherein the control system (10) is configured to provide a clock signal and to synchronize the system controller (16) and the at least one measurement controller (22) with the clock signal.

14. The control system (10) according to any one of the preceding claims, wherein the control system is configured such that the at least one measurement controller (22) is operable independently of the system controller (16) and/or the system controller (16) is operable independently of the at least one measurement controller (22).

15. The control system (10) according to any one of the preceding claims, wherein the system controller (16), the at least one measurement controller (22) and the bus interface (24) are integrated into an integrated circuit.

16. The control system (10) according to any one of the preceding claims, further comprising a RAM memory (40), wherein the control system is configured to store output data created by means of the at least one measurement controller (22), during execution of a measurement function, in the RAM memory (40) and to access the RAM memory (40) by means of the system controller (16) and to read out the output data from the RAM memory (40).

17. Use of a RISC processor (36) as a measurement controller (22) in a control system (10), wherein the measurement controller (22) is operable by means of a predetermined program code provided in a ROM memory (38), and wherein the measurement controller (22) is operable as a finite state machine by means of the predetermined program code.

18. A control device (54) for a motor vehicle, the control device (54) comprising a control system (10) according to any one of claims 1 to 16.

19. A method (500) for providing a control and/or regulating signal, the method comprising:
providing (502) a system bus (14) with a system controller (16), wherein the system controller (16) is configured to execute system functions (18) of the control system (10);
providing (504) a measurement bus (20) with at least one measurement controller (22), wherein the at least one measurement controller (22) is configured to execute measurement functions for acquiring and/or processing measurement data and/or output functions for adapting and/or outputting control and/or regulating signals, wherein the measurement controller (22) is designed as a deterministic, programmable finite-state machine and is configured such that the measurement functions and/or output functions executable by the measurement controller (22) are fully simulable, and wherein the measurement controller (22) is operable by means of a predetermined program code, the measurement controller (22) has a ROM memory (38) and the predetermined program code is provided in the ROM memory (38);
sending (506) a command for executing a measurement function from the system controller (16) to the measurement controller (22) via a bus interface (24), which provides a communication connection (26) between the system bus (14) and the measurement bus (20);
executing (508) the measurement function by the measurement controller (22) and preventing the system controller (16) from accessing the measurement controller (22) during execution of the measurement function by the measurement controller (22); and
providing (510) output data that was created during the execution of the measurement function, wherein the output data is provided to the system controller (16) via the bus interface (24).
